(19) United States
(12) Patent Application Publication
(10) Pub. No.: US 2009/0287472 A1
(43) Pub. Date: Nov. 19, 2009

(54) MULTIPLE LANGUAGE PREFERENCE FOR OPTICAL DISC PLAYERS

(75) Inventor: Koen Holtman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/720,952

(22) PCT Filed: Dec. 6, 2005
(86) PCT No.: PCT/IB05/54080

§ 371 Date: Jun. 6, 2007

Related U.S. Application Data
(60) Provisional application No. 60/633,973, filed on Dec. 7, 2004.

(51) Int. Cl. G06F 17/20

(52) U.S. Cl. 704/8

(57) ABSTRACT

A method of playing an optical disc is disclosed. The method includes language preferences being compared to language tracks on the disc. A language preference is stored in a first register. The language preference is compared to the language tracks on the disc. If the language preference matches one or more of the language tracks on the disc, a value is stored in a second register to identify a matching track. One of the language tracks is read from the disc according to the value stored in the second register.

The present invention relates generally to optical recording, and more particularly, to a technique that enables multiple language preferences to be implemented in an optical disc player that is compatible with existing standards.

In optical discs such as DVD and the proposed Blu-ray, different language versions for both the subtitle and audio tracks are included for the same title. Thus, DVD players and the proposed Blu-ray player include a feature by which a user can set a preferred language for the subtitles and audio tracks of a particular title.

For example, if a user selects “English” as a preferred audio language and a disc with English and French audio tracks is inserted in the player, the English audio will be played automatically without the user having to make any selection. This automatic selection is supported by features in both the DVD and Blu-ray standards. Although, this automatic selection mechanism may be overridden by the disc author of a particular disc, this is usually not the case.

Further, suppose the above user only knows English and German, and a disc is inserted into the player that only has German and French audio. In that case, since this user has selected “English” as the preferred language, the German audio tracks may not be automatically played. Since the disc does not have this user's preferred language “English”, the player will play the default language that is set by the disc author. If the default language is French, this user will not understand the audio being played.

In view of the above, a method of playing an optical disc is disclosed. The method includes language preferences being compared to language tracks on the disc. A language preference is stored in a first register. The language preference is compared to the language tracks on the disc. If the language preference matches one or more of the language tracks on the disc, a value is stored in a second register to identify a matching track. One of the language tracks is read from the disc according to the value stored in the second register. In one example, the language tracks are audio tracks. In another example, the language tracks are sub-title tracks.

An optical disc player is also disclosed. The player includes an initial multi-preference mechanism for comparing language preferences to language tracks on an optical disc and for determining a language preference. It also includes a first register for storing the language preference. It also includes an initial selection mechanism for comparing the language preference stored in the first register to the language tracks on the disc and for determining if the language preference matches one or more of the language tracks on the disc. It also includes a second register for storing a value to identify a matching track if the language preference matches one of the language tracks on the disc. It also includes a playback mechanism for reading one of the language tracks from the disc according to the value stored in the second register. In one example, the language tracks are audio tracks. In another example, the language tracks are sub-title tracks.

Referring now to the drawings where like reference numbers represent corresponding parts throughout:

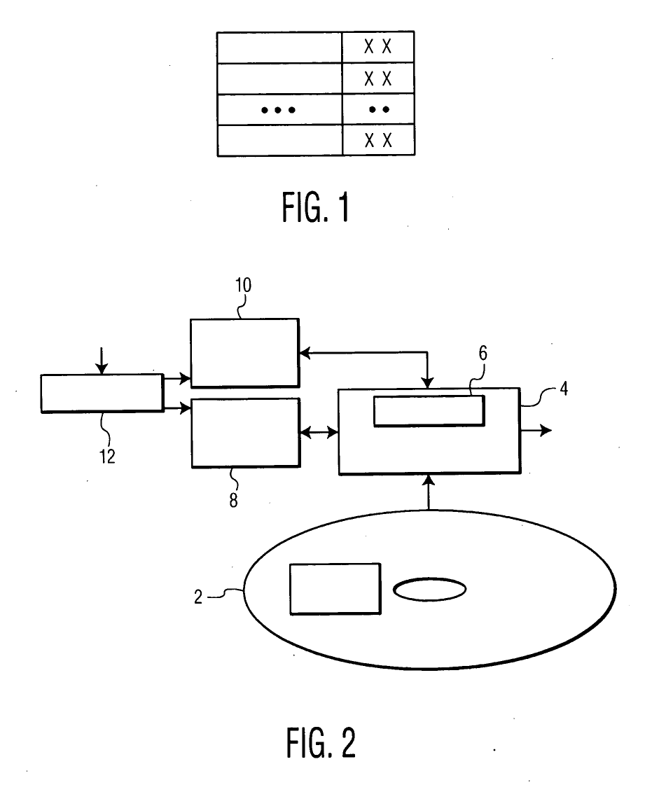

FIG. 1 is an example of an audio track list;

FIG. 2 is a diagram showing one example of an optical disc player according to existing standards;

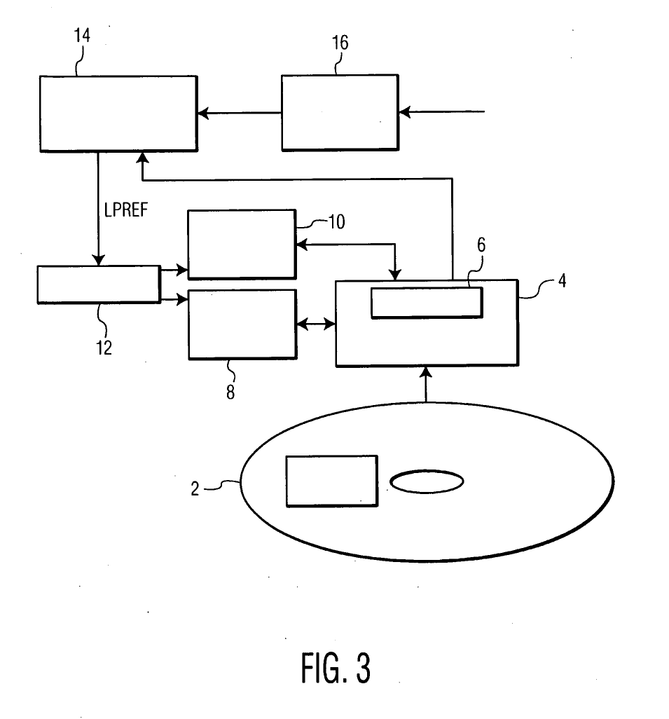

FIG. 3 is one example of an optical disc player according to the present invention;

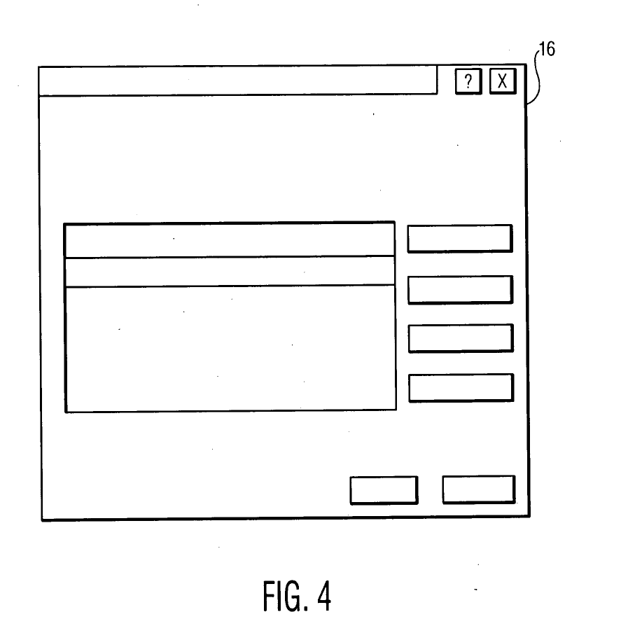

FIG. 4 is one example of an language preference menu; and

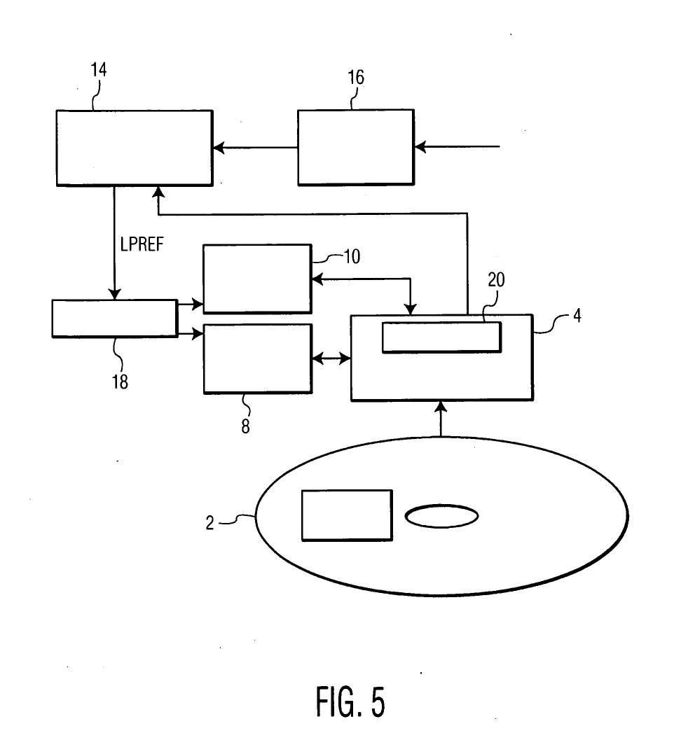

FIG. 5 is another example of an optical disc player according to the present invention.

One example of an optical disc player according to existing standards is shown in FIG. 1. Such existing standards include DVD specifications for Read-Only Disc, part 3: Video specifications, Version 1.1, December 1997, by Toshiba Corporation et al. (hereafter DVD standard) and Blu-ray Disc: System Description Blu-ray Disc Prerecorded format (BD_ROM), Part 3, by Blu-ray Disc Founders/Blue-ray Disc Association (hereafter Blu-ray Standard incorporated by reference).

The disc 2 played by such recorder may include video tracks, audio tracks and subtitle tracks for each title stored on the disc. As previously described, both the audio and sub-title tracks may include different language versions for each title. According to the existing standards, each audio and subtitle track for each title is designated by a code indicating what language the track is in such as EN, DE or FR. These codes are stored on a disc in the form of title lists. An example of one is shown in FIG. 1. As can be seen, a code XX will be associated with each different audio or subtitle track on the disc for each title.

Referring back to FIG. 2, the disc 2 may also include a disc program. During operation, the disc program is used to configure the player. The disc program may also be used to provide overrides determined by the disc author.

As can be seen, the player includes an audio/visual playback mechanism 4. This mechanism 4 includes the hardware and software to read data off the disc 2 and to decode the data so that it may be viewed and heard by a user. The audio/visual playback mechanism 4 includes a register designated as SELAUDIOREG 6. The SELAUDIOREG 6 stores the currently selected language. The language in SELAUDIOREG 6 could be represented as a language code, but it is more common to represent it with an identifying number of the corresponding audio track on the disc For the discussion here, the details of representation are not important. The language representation stored in this register 6 determines the particular audio track that is read from the disc 2.

A program execution mechanism 8 is also included in two way communication with the audio/visual playback mechanism 4. The program execution mechanism 8 will execute the disc program that is stored on the disc 2. During operation, the program execution mechanism 8 will receive the disc program from the audio/visual playback mechanism 4. The program execution mechanism 8 will then configure the audio/visual playback mechanism 4 according to the instructions in the disc program. This may be done automatically or may be initiated by user input. The disc program can read the language code in AUDIOPREFREG 12, and use this code as an input in determining an appropriate configuration for the audio/visual playback mechanism 4.

An initial selection mechanism 10 is also included in two way communication with the audio/visual playback mechanism 4. During operation, the initial selection mechanism 10 will determine the current language code based on the AUDIOPREFREG 12 and the audio/visual playback mechanism 4. However, the selection made by the initial selection mechanism 10 is subject to overrides by the disc author that may be stored on the disc. Such overrides can for example take the form of specific instructions that are inserted in the disc program. As previously described, the current language code determines the particular audio track that is read from the disc 2. The AUDIOPREFREG 12 stores the language code that is preferred by the user. The preferred language code is provided by user input, usually during the initial setup of the player when the player is first used. The user can also change the preferred language code while the device is being used, but, depending on the specifics of the applicable standard, the disc program, and the player implementation, such a change will often not have an immediate effect on the output, but will e.g. only take effect when a new title is played.

The program execution mechanism 8 may be may be embodied by a programmable microprocessor. Further, the initial selection mechanism 10 and AUDIOPREFREG 12 may be embodied by software, hardware or combination thereof.

During operation, the player will be turned on and a disc 2 will be inserted. The disc program is then read from the disc 2 by the audio/visual playback mechanism 4. The disc program is then loaded into the program execution mechanism 8 and executed to configure the audio/visual playback mechanism 4. The disc program may or may not configure the contents of SELAUDIOREG 6 at this point. This is up to the applicable standard and to the author of the disc program. If the SELAUDIOREG 6 is not initially configured by the disc program, then it is configured by the initial selection mechanism 10, as described in more detail below. As previously described, the configuring of the audio/visual playback mechanism 4 (and optionally the SELAUDIOREG 6 inside it) may be done automatically such as when the disc is inserted. Alternatively, it can be done in response to a user input such as pressing another button on the player after the disc 2 is inserted.

As previously described, both the audio and sub-title track stored on the disc 2 may include different language versions for each title. Further, each audio and subtitle track is designated by a code indicating what language the track is in such as EN, DE or FR. For example, if the user has a preference to hear the audio in french, the code in the AUDIOPREREG 12 will have been set by the user to be FR.

Unless it is overriden or pre-empted by the disc program, the initial selection mechanism 10 will determine the current language to played based on the AUDIOPREFREG 12. The initial selection mechanism 10 will compare the code stored in the AUDIOPREFREG 12 with the audio tracks stored on the disc 2 for a particular title. If one of the codes on the disc 2 matches the AUDIOPREFREG 12, the initial selection mechanism 10 will store this code in the SELAUDIOREG 6 of the audio/visual playback mechanism 4. If there is no match, the initial selection mechanism 10 will then select a default language code according to an algorithm in the standards. An example of such an algorithm is in Section 3.3.9.1 of the DVD standard.

In the case that the disc was inserted some time ago, and that another title was previously played from the disc 2 already, the initial selection mechanism 10 will often (depending on the details of the applicable standard and the player implementation) leave the code in the SELAUDIOREG 6 unchanged. This will enable the language selected previously to be used again. It should be noted that the initial selection mechanism 10 may be overridden by the disc program. For example, the disc program may include a language specified by the disc author. For example, the disc program may specify that a particular title may only be played in French. Thus, say that the initial selection mechanism 10 stores the language code for English in the SELAUDIOREG 6 as a result of the above described operations. The disc program executed by the program execution mechanism will override the initial selection mechanism 10 and change the code to French as specified by the disc program. The disc program may also override the initial selection mechanism 10 while the playing of the title is already in progress, e.g. when it is initiated to do so by user input.

As a result of the above-described operations, a value that specifies a particular language is stored in the SELAUDIOREG 6. A previously described, this value may be a language code or an identifying number of a corresponding audio track. The audio/visual playback mechanism 4 will then read and decode the audio track corresponding to the value in the SELAUDIOREG 6. Thus, the audio will be output from the player in the language according to the value in the SELAUDIOREG 6. If the value stored in the SELAUDIOREG 6 is the same as the user preference, the user should always be able to understand the audio being played. However, if the value stored in the SELAUDIOREG 6 is different than the user preference, the user may not be able to understand the audio being played. For example, if the user's language preference is English and there are no English tracks on the disc 2. The player will have to pick another language as a default. If the user does not know this default language, the audio being played may not be understood by the user.

In view of the above, it would be desirable to implement multiple language preferences that would be compatible with existing standards such as the Blu-ray and DVD Standards. One example of such an optical disc player is shown in FIG. 3. The player of FIG. 3 is the same as FIG. 2 except that two additional features are included. As can be seen, a Language Preference Menu 16 is included that enables a user to specify a list of language preferences. An Initial Multi-Preference Mechanism 14 is also included that determines the language code stored in the AUDIOPREFREG 12 based on the language preference list of the Language Preference Menu 16 and inputs from the audio/visual playback mechanism 4. Both the Language Preference Menu 16 and Initial Multi-Preference Mechanism 14 may be embodied by software, hardware or combination thereof.

During operation, a user will input a number of language preferences into the Language Preference Menu 16. These language preferences are the languages the user prefers the audio to be output by the player. It is preferred that the user input these preferences in a way that indicates the order of preference. In one example, the most preferred would be put in first. In another example, the most preferred would be last. The Language Preference Menu 16 will then generate a language list that includes language codes that correspond to the user's language preferences.

The Initial Multi-Preference Mechanism 14 will then compare the codes stored in the language list to the audio tracks stored on the disc 2. Comparison could, for example, be with the languages list for the audio tracks of a particular title, with the comparison performed just before playback of that title is started. As another example, comparison could be with all audio tracks on the disc, regardless of title, with the comparison performed when the disc is first inserted. If one of the codes on the disc 2 matches a code in the language list, the Multi-Preference Mechanism 14 will store this code in the AUDIOPREFREG 12. If more than one code matches, it is preferable that the code of the most preferred language in the language list is stored in the AUDIOPREFREG 12. If there is no match, the code of the most preferred language in the language list is stored in the AUDIOPREFREG 12.

As described above, the Multi-Preference Mechanism 14 will select what language code is stored in the AUDIOPREFREG 12. By making this selection based on multiple language preferences it is more likely that a user will understand the audio output by the player.

During operation, the rest of the player will operate as previously described in regard to FIG. 2. For example, the initial selection mechanism 10 will compare the code stored in the AUDIOPREFREG 12 with the audio tracks stored on the disc 2 for a particular title. If one of the codes on the disc 2 matches the AUDIOPREFREG 12, the initial selection mechanism 10 will store a value that specifies a particular language in the SELAUDIOREG 6 of the audio/visual playback mechanism 4. If there is no match, the initial selection mechanism 10 will then select a default value according to an algorithm in the standards. An example of such an algorithm is in Section 3.3.9.1 of the DVD standard.

The audio/visual playback mechanism 4 will then read and decode the audio track corresponding to the value in the SELAUDIOREG 6. Thus, the audio will be output from the player in the language according to the value in the SELAUDIOREG 6.

One example of a Language Preference Menu is shown in FIG. 4. As can be seen, this example is implemented in a dialog box of the INTERNET EXPLORER. In this example, the user has input English-U.S., Dutch and English-U.K. as the language preferences. In one example, English-U.S. is the most preferred.

Another example of an optical player that implements multiple language preferences is shown in FIG. 5. This example operates the same as FIG. 3 same except that it is used to select a sub-title track instead of an audio track. Therefore, the registers in the example of FIG. 3 has been changed to SUBTITPREFREG 18 and SELSUBTITREG 20.

During operation, the initial selection mechanism 10 will compare the code stored in the SUBTITPREFREG 18 with the sub-title tracks stored on the disc 2 for a particular title. If one of the codes on the disc 2 matches the SUBTITPREFREG 18, the initial selection mechanism 10 will store a value that specifies a particular language in the SELSUBTITREG 20 of the audio/visual playback mechanism 4. If there is no match, the initial selection mechanism 10 will then select a default value according to an algorithm in the standards. An example of such an algorithm is in Section 3.3.9.1 of the DVD standard. The audio/visual playback mechanism 4 will then read and decode the subtitle track corresponding to the value in the and SELSUBTITREG 20. Therefore, the audio will be output from the player in the language according to the value in the SELSUBTITREG 20.

While the present invention has been described above in terms of specific examples, it is to be understood that the invention is not intended to be confined or limited to the examples disclosed herein. Therefore, the present invention is intended to cover various structures and modifications thereof included within the spirit and scope of the appended claims.

1. A method of playing an optical disc, comprising the steps of:
comparing language preferences to language tracks on the disc (2);
storing a language preference in a first register (12 or 18);
comparing the language preference to the language tracks on the disc (2);
if the language preference matches one or more of the language tracks on the disc, storing a value in a second register (6 or 20) to identify a matching track; and
reading one of the language tracks from the disc according to the value stored in the second register (6 or 20).

2. The method of claim 1, wherein the language tracks are audio tracks or sub-title tracks.

3. The method of claim 2, wherein the language preference matches one of the language tracks on the disc (2).

4. The method of claim 1, wherein the language preference does not match one of language tracks on the disc (2) and is a most preferred language preference.

5. The method of claim 1, wherein the language preferences are input by a user.

6. The method of claim 5, wherein the language preferences are input by the user in order of preference.

7. The method of claim 1, which further comprises storing an other value indicating a default language preference in the second register (6 or 20) if the language preference in the first register (12 or 18) does not match one of the language tracks on the disc.

8. The method of claim 7, which further comprises reading one of the language tracks from the disc (2) according to the other value stored in the second register (6 or 20).

9. An optical disc player, comprising:
an initial multi-preference mechanism (14) for comparing language preferences to language tracks on an optical disc (2) and for determining a language preference;
a first register (12 or 18) for storing the language preference;
an initial selection mechanism (10) for comparing the language preference stored in the first register (12 or 18) to the language tracks on the disc (2) and for determining if the language preference matches one or more of the language tracks on the disc (2);
a second register (6 or 20) for storing a value to identify a matching track if the language preference matches one of the language tracks on the disc (2); and
a playback mechanism (4) for reading one of the language tracks from the disc (2) according to the value stored in the second register (6 or 20).

10. The player of claim 1, wherein the language tracks are audio tracks or sub-title tracks.

11. The player of claim 9, wherein the language preference matches one of the language tracks on the disc (2).

12. The player of claim 9, wherein the language preference does not match one of language tracks on the disc (2) and is a most preferred language preference.

13. The player of claim 9, wherein the language preferences are input into a language preference menu (16).

14. The player of claim 13, wherein the language preferences are input into the language preference menu (16) in order of preference.

15. The player of claim 9, wherein the initial selection mechanism (14) stores another value indicating a default language preference in the second register (6 or 20) if the language preference in the first register (12 or 18) does not match one of the language tracks on the disc (2).

16. The player of claim 15, wherein the playback mechanism (4) reads one of the language tracks from the disc (2) according to the other value stored in the second register (6 or 20).
